(19) United States
(12) Patent Application Publication
(10) Pub. No.: US 2017/0147122 A1
(43) Pub. Date: May 25, 2017

(54) Capacitive Touch Substrate and Touch Display Screen

(71) Applicants: BOE Technology Group Co., Ltd., Beijing (CN); HEFEI BOE Optoelectronics Technology Co., Ltd., Hefei (CN)

(72) Inventors: Honggang Gu, Beijing (CN); Xianjie Shao, Beijing (CN); Bo Liu, Beijing (CN); Jie Song, Beijing (CN)

(73) Assignees: BOE Technology Group Co., Ltd., Beijing (CN); HEFEI BOE Optoelectronics Technology Co., Ltd., Hefei (CN)

(21) Appl. No.: 15/110,370

(22) PCT Filed: Dec. 22, 2015
(86) PCT No.: PCT/CN2015/098267

§ 371 Date: Jul. 7, 2016

(30) Foreign Application Priority Data
Jul. 17, 2015 (CN) 201510427798.2

(51) Int. Cl. G06F 3/041; G06F 3/044

(52) U.S. Cl. CPC G06F 3/0416; G06F 3/0412; G06F 3/044

(57) ABSTRACT

A capacitive touch substrate and a touch display screen are provided. The capacitive touch substrate comprises a plurality of groups of touch electrodes provided in parallel along a first direction. Each group of the touch electrodes includes: a plurality of first touch electrodes provided in a column along a second direction, which are driven independently; a second touch electrode extending along the second direction; and a third touch electrode extending along the second direction. The first touch electrode, the second touch electrode and the third touch electrode are provided sequentially along the second direction. The capacitive touch substrate improves touch accuracy on a premise that a number of wires is not changed and reduces the number of wires on a premise that the touch accuracy is not changed.

### TECHNICAL FIELD

At least one embodiment of the present disclosure provides a capacitive touch substrate and a touch display screen.

### BACKGROUND

With rapid development of a display technology, a touch display screen has gradually become widespread in people's lives.

According to configuration, the touch display screen is divided into three types: an Add-on type touch display screen, an On-cell type touch display screen, and an In-cell type touch display screen. The Add-on type touch display screen comprises an independent touch substrate formed by integrating a touch structure with a protective substrate and provided outside a display panel (e.g., a liquid crystal panel), that is, the touch substrate and the display panel are fabricated separately and then bonded together to form the liquid crystal display screen having the touch function. Both the On-cell type touch display screen and the In-cell type touch display screen are formed by integrating the touch structure with the display panel, and a difference therebetween is that: in the On-cell type touch display screen, the touch structure is formed on a surface of an opposed substrate (e.g., a color filter substrate) on a side away from an array substrate in the display panel; and in the In-cell type touch display screen, the touch structure is provided inside the display panel, for example, the touch structure is provided on a side of the opposed substrate facing the array substrate in the display panel, and/or the touch structure is provided on the array substrate.

### SUMMARY

According to at least one of embodiments of the disclosure, a capacitive touch substrate and a touch display screen are provided, so that touch accuracy is improved on a premise that a number of wires is not changed and the number of wires is reduced on a premise that the touch accuracy is not changed.

According to at least one of the embodiments of the disclosure, a capacitive touch substrate is provided. The capacitive touch substrate comprises a plurality of groups of touch electrodes provided in parallel along a first direction. Each group of the touch electrodes includes: a plurality of first touch electrodes provided in a column along a second direction, the plurality of first touch electrodes being driven independently; a second touch electrode extending along the second direction; and a third touch electrode extending along the second direction. The first touch electrode, the second touch electrode and the third touch electrode are provided sequentially along the first direction.

According to at least one of the embodiments of the disclosure, a touch display screen is provided. The touch display screen comprises the capacitive touch substrate as described above.

### BRIEF DESCRIPTION OF THE DRAWINGS

In order to clearly illustrate the technical solution of the embodiments of the present disclosure, the drawings of the embodiments will be briefly described in the following; it is obvious that the described drawings are only related to some embodiments of the present disclosure and thus are not limitative of the present disclosure.

FIG. 1a is a schematic view illustrating a touch electrode of a self-capacitive touch display screen;

FIG. 1b and FIG. 1c are schematic views illustrating an operation of the self-capacitive touch;

FIG. 2a is a schematic view illustrating a touch electrode of a mutual-capacitive touch display screen;

FIG. 2b and FIG. 2c are schematic views illustrating an operation of the mutual-capacitive touch;

FIG. 3 is a schematic view illustrating a touch electrode of a self-capacitive touch display screen according to embodiments of the present disclosure;

FIG. 4 is a schematic view illustrating a touch electrode of a mutual-capacitive touch display screen according to the embodiments of the present disclosure;

FIG. 5 is a top view schematic view illustrating a capacitive touch substrate according to the embodiments of the present disclosure;

FIG. 6 is a structural schematic view in the case that the capacitive touch substrate according to the embodiments of the present disclosure is a color filter substrate;

FIG. 7 is a structural schematic view in the case that the capacitive touch substrate according to the embodiments of the present disclosure is an array substrate; and

FIG. 8 is a cross-sectional structural schematic view illustrating a touch display screen according to the embodiments of the present disclosure.

### DETAILED DESCRIPTION

In order to make objects, technical details and advantages of the embodiments of the present disclosure apparent, the technical solutions of the embodiment will be described in a clearly and fully understandable way in connection with the drawings related to the embodiments of the present disclosure. It is obvious that the described embodiments are just a part but not all of the embodiments of the present disclosure. Based on the described embodiments herein, those skilled in the art can obtain other embodiment(s), without any inventive work, which should be within the scope of the present disclosure.

Unless otherwise defined, technical terms or scientific terms used in the present disclosure should be of general meaning as understood by those ordinarily skilled in the art. “First”, “second” and similar words used in the present disclosure do not represent any sequence, quantity or importance and merely intend to differentiate different composite parts. Similarly, words such as “one”, “a/an” or “the” or the like do not denote quantitative limitation, but rather indicate there is at least one. Words such as “include” or “comprise” and the like denote that elements or objects appearing before the words of “include” or “comprise” cover the elements or the objects enumerated after the words of “include” or “comprise” or equivalents thereof, not exclusive of other elements or objects. Words such as “connected” or “connecting” and the like are not limited to physical or mechanical connections, but may include electrical connection, either direct or indirect. Words such as “up”, “down”, “left”, “right” and the like are only used for expressing relative positional relationship, in the case that the absolute position of a described object is changed, the relative positional relationship may also be correspondingly changed.

For example, a capacitive touch display screen includes a self-capacitive touch display screen and a mutual-capacitive touch display screen.

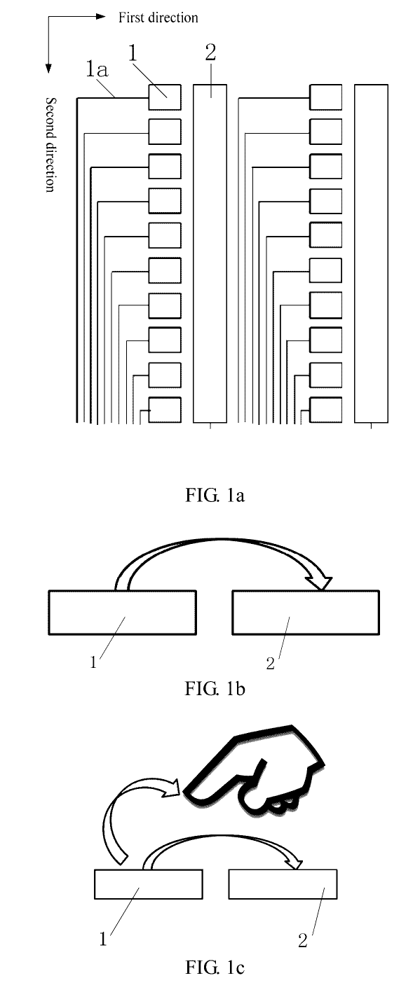

FIG. 1a is a schematic view illustrating a touch electrode of a self-capacitive touch display screen, and FIG. 1b and FIG. 1c are schematic views illustrating an operation of the self-capacitive touch.

As shown in FIG. 1a, the self-capacitive touch display screen includes a plurality of groups of touch electrodes provided along a first direction, and each group of the touch electrodes includes a plurality of channel electrodes 1 provided in a column along a second direction and a column of a grounding electrode 2 extending along the second direction, and each channel electrode 1 is connected with a wire 1a connected with a touch chip (not shown). The channel electrode 1 implements a touch function in a manner of self-emitting and self-receiving. That is, in the case that the channel electrode 1 is not touched, as shown in FIG. 1b, a capacitance Cp is formed between the channel electrode 1 and the grounding electrode 2; in the case that the channel electrode 1 is touched, as shown in FIG. 1c, the capacitance between the channel electrode 1 and the grounding electrode 2 is increased to Cp+ΔC, and at this time, a touch position is determined by detecting a changed amount ΔC of the capacitance between the channel electrode 1 and the grounding electrode 2.

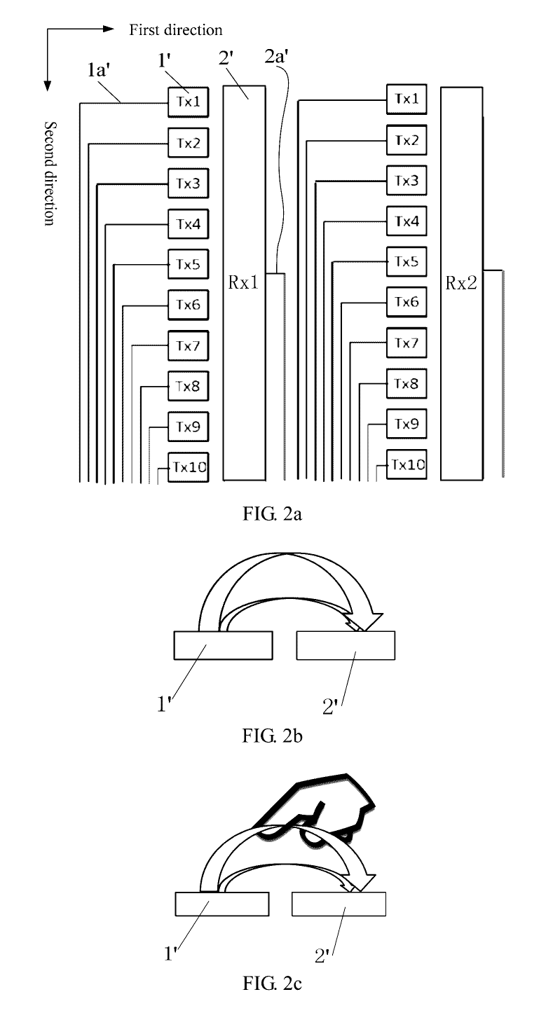

FIG. 2a is a schematic view illustrating a touch electrode of a mutual-capacitive touch display screen, and FIG. 2b and FIG. 2c are schematic views illustrating an operation of the mutual-capacitive touch.

As shown in FIG. 2a, the mutual-capacitive touch display screen includes a plurality of groups of touch electrodes provided along a first direction, and each group of the touch electrodes includes a plurality of touch driving electrodes 1′ provided in a column along a second direction and a column of a touch sensing electrode 2′ extending along the second direction, and each touch driving electrode 1′ is connected with a wire 1a′, and the touch sensing electrode 2′ is connected with a wire 2a′ connected with a touch chip (not shown). FIG. 2a only shows two groups of the touch electrodes, each group of the touch electrodes includes touch driving electrodes Tx1, Tx2, . . . and Tx10 provided in the column along the second direction, and each group of the touch electrodes includes one touch sensing electrode (such as the touch sensing electrode Rx1 in the left group, the touch sensing electrode Rx2 in the right group). As shown in FIG. 2b, in the case that the touch driving electrode 1′ and the touch sensing electrode 2′ are not touched, a mutual capacitance Cm is formed between the touch driving electrode 1′ and the touch sensing electrode 2′; by applying a driving signal on the touch driving electrode 1′, due to existence of the mutual capacitance, the touch sensing electrode 2′ senses and receives the driving signal. As shown in FIG. 2c, in the case that a touch object (e.g., a finger of human) is close to or approaches the touch driving electrode 1′ and/or the touch sensing electrode 2′, part of an electrical field between the touch driving electrode 1′ and the touch sensing electrode 2′ is transferred to the touch object, so that the mutual capacitance between the touch driving electrode 1′ and the touch sensing electrode 2′ is reduced to Cm−ΔC, and thus a touch position is determined according to a changed amount ΔC of the mutual capacitance.

In studies, inventors of the present disclosure note that, for situations shown in FIG. 1a and FIG. 2a, if a width of each group of the touch electrodes (i.e., touch accuracy) is 5 to 8 mm, because there are a lot of the channel electrodes 1 or the touch driving electrodes 1′, a lot of wires are needed, and an area occupied by the wires is large, resulting in great difficulty in connection between those wires and the touch chip, and easily causing defective connection between the wires and the touch chip.

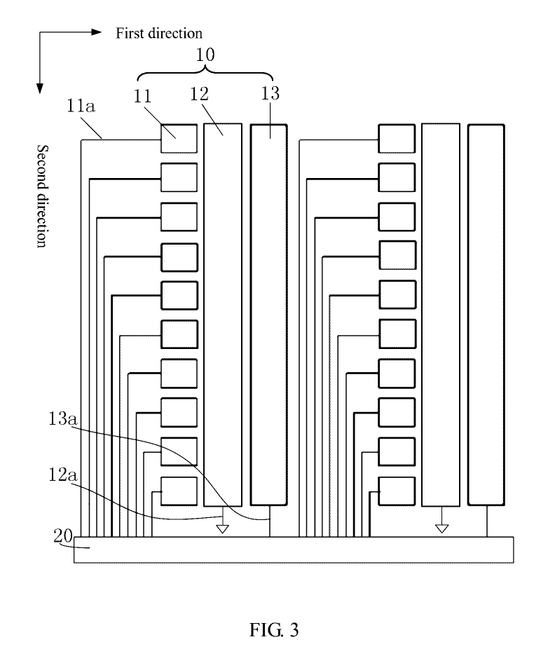

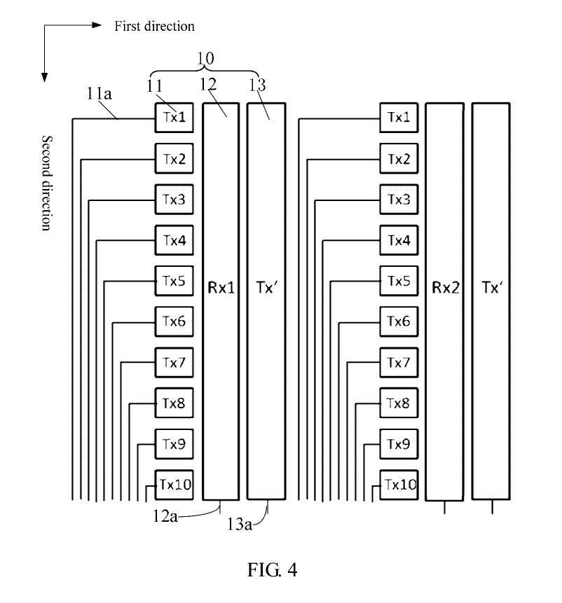

As shown in FIG. 3 and FIG. 4, at least one embodiment of the present disclosure provides a touch substrate, and the touch substrate comprises a plurality of groups of touch electrodes 10 provided in parallel along a first direction. Each group of the touch electrodes 10 includes: a plurality of first touch electrodes 11 provided in a column along a second direction, which are driven independently; a second touch electrode 12 extending along the second direction; and a third touch electrode 13 extending along the second direction. The first touch electrode 11, the second touch electrode 12 and the third touch electrode 13 are provided sequentially along the first direction. As shown in the drawings, the first direction is in a transverse direction, and the second direction is in a longitudinal direction, and therefore, the first direction and the second direction are perpendicular to each other, but the present disclosure is not limited thereto.

For example, as shown in FIG. 3, the touch substrate according to at least one embodiment of the present disclosure works as a self-capacitive touch substrate, that is, the first touch electrode 11 is a self-capacitive electrode and is configured to be connected with a touch chip 20, the second touch electrode 12 is configured to be grounded, and the third touch electrode 13 is configured to be connected with the touch chip 20.

It should be noted that, the touch chip 20 is provided on the touch substrate, or provided on the other part except the touch substrate in a touch display screen including the touch substrate; for example, the touch chip 20 is connected with the touch substrate through a flexible circuit board.

In the case that the touch substrate works as the self-capacitive touch substrate, an operation thereof is as follows: in the case that the first touch electrode 11 in the group of the touch electrodes 10 (e.g., the touch electrode group located on a left side in FIG. 3) is touched, a touch position is determined according to change in a capacitance between the first touch electrode 11 and the second touch electrode 12, for example, the touch position is determined in a manner shown in FIG. 1b and FIG. 1c, that is, a position (i.e., a Y-axis coordinate) of the touch position on the touch substrate along the second direction is determined by the first touch electrode 11, and a position (i.e., a X-axis coordinate) of the touch position on the touch substrate along the first direction is determined by the second touch electrode 12; in the case that the third touch electrode 13 in the group of the touch electrodes is touched, a first coordinate (i.e., a transverse coordinate shown in FIG. 3, that is, a X-axis coordinate) of the touch position is determined by the third touch electrode 13, and because the touch position is close to a position of the first touch electrodes 11 in a next group of the touch electrodes (e.g., the touch electrode group located on a right side in FIG. 3), a second coordinate (i.e., a longitudinal coordinate shown in FIG. 3, that is, a Y-axis coordinate) of the touch position is determined by the first touch electrode 11 in the next group of the touch electrodes, and thus the touch position is determined.

For example, as shown in FIG. 4, the touch substrate according to at least one embodiment of the present disclosure works as a mutual-capacitive touch substrate, that is, in each group of the touch electrodes 10, the first touch electrode 11 is a first touch driving electrode, the second touch electrode 12 is a touch sensing electrode, and the third touch electrode 13 is a second touch driving electrode. Electrodes Tx1, Tx2, . . . , Tx10 . . . in the first touch electrode 11 are respectively connected with or scanned at a same time as their corresponding electrodes in the respective groups of the touch electrodes 10, to form equivalent row electrodes; and the second touch electrodes 12 are the touch sensing electrodes to form equivalent column electrodes.

In the case that the touch substrate works as the mutual-capacitive touch substrate, an operation thereof is as follows: in the case that at least one of the first touch electrode 11 (e.g., any one of Tx1, Tx2, . . . , Tx10 . . . in the touch electrode group located on a left side in FIG. 4) in the group of the touch electrodes 10 (two groups of the touch electrodes are shown in FIG. 4) and the touch sensing electrode 12 (Rx1) is touched, a touch position is determined according to change in a mutual capacitance between the first touch electrode 11 and the touch sensing electrode 12, for example, the position is determined in a manner shown in FIG. 2b and FIG. 2c, that is, a position (i.e., a Y-axis coordinate) of the touch position on the touch substrate along the second direction is determined by the first touch electrode 11, and a position (i.e., a X-axis coordinate) of the touch position on the touch substrate along the first direction is determined by the touch sensing electrode 12; in the case that the third touch electrode 13 is touched, a first coordinate (i.e., a transverse coordinate shown in FIG. 4, that is, a X-axis coordinate) of the touch position is determined by the third touch electrode 13, and because the touch position is close to a position of the first touch electrode 11 (any one of Tx1, Tx2, . . . , Tx10 . . . in the touch electrode group located on a right side in FIG. 4) in a next group of the touch electrodes, a second coordinate (i.e., a longitudinal coordinate shown in FIG. 4, that is, a Y-axis coordinate) of the touch position is determined by the first touch electrode 11 in the next group of the touch electrodes, and thus the touch position is determined.

In the embodiments of the present disclosure, each group of the touch electrodes in the self-capacitive touch substrate includes two columns of the channel electrodes and one column of the grounding electrode, or each group of the touch electrodes in the mutual-capacitive touch substrate includes two columns of the touch driving electrodes and one column of the touch sensing electrode, so that touch accuracy is significantly improved in a case that a number of wires is not changed. Taking an example that the touch accuracy of each group of the touch electrodes in situations shown in FIG. 1a and FIG. 2a is 8 mm, the touch substrate working as the self-capacitance substrate or the mutual-capacitance substrate according to the embodiments of the present disclosure increases the touch accuracy by 4 to 5 mm (e.g., in a case that widths of the first touch electrode, the second touch electrode and the third touch electrode along the first direction are almost same). In addition, in a premise that the touch accuracy is not changed, the embodiments of the present disclosure greatly reduce the number of the wires, so as to improve efficiency in connections between the wires and the touch chip.

In at least one embodiment, the first touch electrode 11, the second touch electrode 12 and the third touch electrode 13 for example are only used for the touch function, but the embodiments of the present disclosure are not limited thereto, for example, they are all further used as a common electrode and are applied with a common voltage at a specific time. Taking a liquid crystal display device as an example, the common electrode is provided on an array substrate or an opposed substrate (e.g., a color filter substrate) included in the liquid crystal display device to form an electric field with a pixel electrode provided on the array substrate to control rotations of liquid crystal molecules, thereby realizing a display function. In order that the first, second and third electrodes are used as the touch electrode as well as the common electrode, as shown in FIG. 5, the first, second and third electrodes described above are further connected with a common voltage driving circuit 30, so as to be applied the common voltage at a proper time.

For example, a display time of a frame of image is divided into a display period and a touch period; in the touch period for realizing the touch function, the first touch electrode 11, the second touch electrode 12 and the third touch electrode 13 determine the touch position in the operation manner described above; and in the display period for realizing the display function, the first touch electrode 11, the second touch electrode 12 and the third touch electrode 13 are applied with the common voltage to be used as the common electrode, to form the driving electric field with the pixel electrodes to drive the liquid crystal molecules to rotate. The time-division operation manner described above reduces mutual interference between the display operation and the touch operation.

FIG. 5 is described by taking an example that the first touch electrode 11, the second touch electrode 12 and the third touch electrode 13 are all connected with the common voltage driving circuit. Of course, the embodiments of the present disclosure are not limited thereto. For example, part of the first touch electrode 11, the second touch electrode 12 and the third touch electrode 13 (e.g., one or two of the first touch electrode 11, the second touch electrode 12 and the third touch electrode 13) is connected with the common voltage driving circuit, so that this part of the first touch electrode 11, the second touch electrode 12 and the third touch electrode 13 is used as the common electrode.

For example, in the touch substrate according to any one of the embodiments described above, the first touch electrode 11, the second touch electrode 12 and the third touch electrode 13 are all transparent electrodes. The first, second and third touch electrodes are all provided in a display region of the touch substrate; in this case, they are provided as transparent electrodes to prevent a reduction of aperture ratio. For example, the first touch electrode 11, the second touch electrode 12 and the third touch electrode 13 are made of transparent metal oxide such as Indium Tin Oxide (ITO), Indium Gallium Zinc Oxide (IGZO) and so on.

For example, each first touch electrode 11 is connected with a leading wire 11a, each second touch electrode 12 is connected with a leading wire 12a, and each third touch electrode 13 is connected with a leading wire 13a, so as to transmit signals between the first, second and third touch electrodes and other parts, respectively.

For example, the capacitive touch substrate according to at least one embodiment of the present disclosure is formed independently, or is formed to be a color filter substrate or an array substrate.

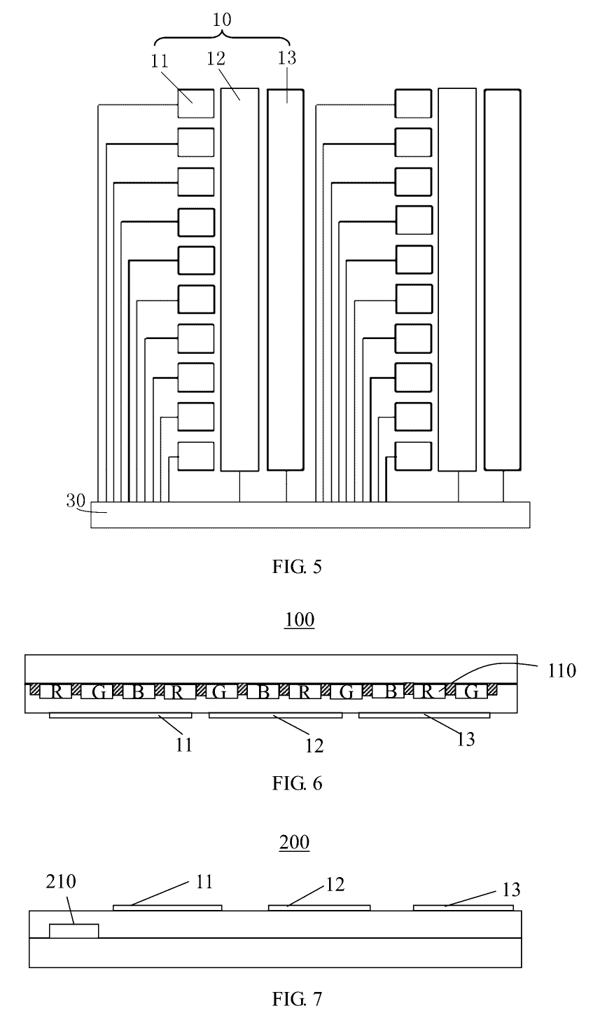

For example, as shown in FIG. 6, the capacitive touch substrate according to at least one embodiment of the present disclosure is a color filter substrate 100, a color filter layer 110 (e.g., including a red color filter R, a green color filter G and a blue color filter B) is provided on the color filter substrate 100, and the first touch electrode 11, the second touch electrode 12 and the third touch electrode 13 are formed on an upper side and/or a lower side of the color filter substrate 100. That is to say, the first touch electrode 11, the second touch electrode 12 and the third touch electrode 13 are all provided on a side of the color filter substrate 100 where the color filter layer 110 is provided, or are all provided on a side of the color filter substrate 100 where the color filter layer 110 is not provided, or part of the first touch electrode 11, the second touch electrode 12 and the third touch electrode 13 is provided on the side of the color filter substrate 100 where the color filter layer 110 is provided and the other part of the first touch electrode 11, the second touch electrode 12 and the third touch electrode 13 is provided on the side of the color filter substrate 100 where the color filter layer 110 is not provided. The color filter substrate 100, for example, is bonded with the array substrate to form the display panel.

Alternatively, for example, as shown in FIG. 7, the capacitive touch substrate according to at least one embodiment of the present disclosure is an array substrate 200, and the first touch electrode 11, the second touch electrode 12 and the third touch electrode 13 are formed on a side of the array substrate 200. Of course, an array of sub-pixel units is further provided on the array substrate, each sub-pixel unit for example includes a thin film transistor 210, an insulating layer, a pixel electrode and other structures, which will not be repeated here. The array substrate 200, for example, is used in a liquid crystal display device, and bonded with an opposed substrate to form the liquid crystal display device; or the array substrate 200, for example, is used in an Organic Light-Emitting Diode (OLED) display device.

In addition, the touch substrate according to the embodiments of the present disclosure for example further comprises a base substrate (e.g., a glass substrate, a quartz substrate or a plastic substrate), the first, second and third touch electrodes described above are provided on the base substrate, and are located on a same side or different sides of the base substrate.

At least one embodiment of the present disclosure further provides a touch display screen, which comprises the capacitive touch substrate according to any one of the embodiments described above. For example, the touch display screen is a liquid crystal display screen or an organic light-emitting display screen.

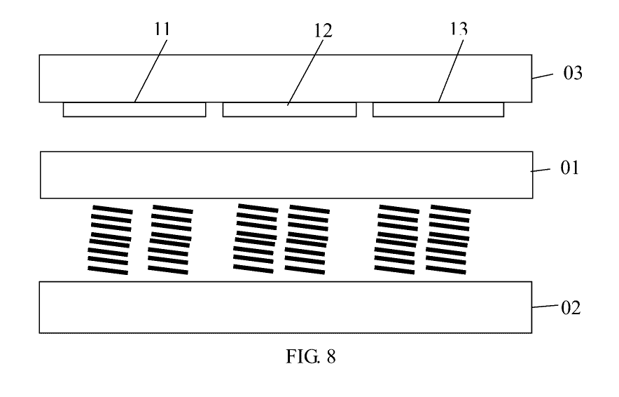

For example, as shown in FIG. 8, the touch display screen according to the embodiments of the present disclosure comprises an array substrate 02, or the touch display screen comprises an array substrate 02 and an opposed substrate 01 (e.g., a color filter substrate) provided opposite to the array substrate 02, or the touch display screen comprises an array substrate 02, an opposed substrate 01 (e.g., a color filter substrate) provided opposite to the array substrate 02 and a protective substrate 03 provided on a side of the opposed substrate 01 away from the array substrate 02; and furthermore, the capacitive touch substrate according to any one of embodiments described above is any one of the array substrate 02, the opposed substrate 01 and the protective substrate 03 in the touch display screen. In addition, according to different positions of the first touch electrode 11, the second touch electrode 12 and the third touch electrode 13 on the touch display screen, the touch display screen according to the embodiments of the present disclosure is formed as an Add-on type touch display screen, an On-cell type touch display screen, or an In-cell type touch display screen.

FIG. 8 is described by taking an example that the touch display screen is the liquid crystal display screen and the capacitive touch substrate is the protective substrate 03 (i.e., the first touch electrode 11, the second touch electrode 12 and the third touch electrode 13 are provided on the protective substrate 03), but the present disclosure is not limited thereto.

The touch display screen according to the embodiments of the present disclosure may be: a liquid crystal panel, an E-paper, an OLED panel, a touch panel, a cell phone, a tablet computer, a television, a monitor, a notebook computer, a digital frame, a navigator or any other product or part having a display and touch function.

The foregoing embodiments merely are exemplary embodiments of the disclosure, and not intended to define the scope of the disclosure, and the scope of the disclosure is determined by the appended claims.

The application claims priority of Chinese Patent Application No. 201510427798.2 filed on Jul. 17, 2015, the disclosure of which is incorporated herein by reference in its entirety as part of the present application.

1. A capacitive touch substrate, comprising a plurality of groups of touch electrodes provided in parallel along a first direction, wherein,
each group of the touch electrodes includes:
a plurality of first touch electrodes provided in a column along a second direction, the plurality of first touch electrodes being driven independently;
a second touch electrode extending along the second direction; and
a third touch electrode extending along the second direction, and
the first touch electrode, the second touch electrode and the third touch electrode are provided sequentially along the first direction.

2. The capacitive touch substrate according to claim 1, wherein, the first touch electrode is a self-capacitive electrode and is configured to be connected with a touch chip, the second touch electrode is configured to be grounded, and the third touch electrode is configured to be connected with the touch chip.

3. The capacitive touch substrate according to claim 1, wherein, the first touch electrode is a first touch driving electrode, the second touch electrode is a touch sensing electrode, and the third touch electrode is a second touch driving electrode.

4. The capacitive touch substrate according to claim 1, wherein, at least one of the first touch electrode, the second touch electrode and the third touch electrode is configured to be connected with a common voltage driving circuit.

5. The capacitive touch substrate according to claim 1, wherein, the capacitive touch substrate is a color filter substrate, and the first touch electrode, the second touch electrode and the third touch electrode are formed an upper side and/or a lower side of the color filter substrate.

6. The capacitive touch substrate according to claim 1, wherein, the capacitive touch substrate is an array substrate, and the first touch electrode, the second touch electrode and the third touch electrode are formed on a side of the array substrate.

7. The capacitive touch substrate according to claim 1, wherein, the first touch electrode, the second touch electrode and the third touch electrode are all transparent electrodes.

8. A touch display screen, comprising the capacitive touch substrate according to claim 1.

9. The touch display screen according to claim 8, wherein, the touch display screen is a liquid crystal display screen or an organic light-emitting diode display screen.

10. The capacitive touch substrate according to claim 2, wherein, at least one of the first touch electrode, the second touch electrode and the third touch electrode is configured to be connected with a common voltage driving circuit.

11. The capacitive touch substrate according to claim 3, wherein, at least one of the first touch electrode, the second touch electrode and the third touch electrode is configured to be connected with a common voltage driving circuit.

12. The capacitive touch substrate according to claim 2, wherein, the capacitive touch substrate is a color filter substrate, and the first touch electrode, the second touch electrode and the third touch electrode are formed an upper side and/or a lower side of the color filter substrate.

13. The capacitive touch substrate according to claim 3, wherein, the capacitive touch substrate is a color filter substrate, and the first touch electrode, the second touch electrode and the third touch electrode are formed an upper side and/or a lower side of the color filter substrate.

14. The capacitive touch substrate according to claim 4, wherein, the capacitive touch substrate is a color filter substrate, and the first touch electrode, the second touch electrode and the third touch electrode are formed an upper side and/or a lower side of the color filter substrate.

15. The capacitive touch substrate according to claim 2, wherein, the capacitive touch substrate is an array substrate, and the first touch electrode, the second touch electrode and the third touch electrode are formed on a side of the array substrate.

16. The capacitive touch substrate according to claim 3, wherein, the capacitive touch substrate is an array substrate, and the first touch electrode, the second touch electrode and the third touch electrode are formed on a side of the array substrate.

17. The capacitive touch substrate according to claim 4, wherein, the capacitive touch substrate is an array substrate, and the first touch electrode, the second touch electrode and the third touch electrode are formed on a side of the array substrate.
